(19) United States
(12) Patent Application Publication
(10) Pub. No.: US 2004/0243511 A1
(43) Pub. Date: Dec. 2, 2004

(54) Method and apparatus to create and execute time-bound constraints

(75) Inventor: Jeffrey A. Grossman, Beaverton, OR (US)

Correspondence Address: CAMPBELL STEPHENSON ASCOLESE, LLP, 4807 SPICEWOOD SPRINGS RD., BLDG. 4, SUITE 201, AUSTIN, TX, 78759, US

(73) Assignee: Corillian Corporation

(21) Appl. No.: 10/446,863

(22) Filed: May 28, 2003

(51) Int. Cl. G06F 17/60

(52) U.S. Cl. 705/39

(57) ABSTRACT

A method to execute a time-bound constraint comprising generating a time-bound constraint record comprising a user id, a transaction, a transaction parameter, a time period, an update time, a rule and a rule accumulator. Receiving a request said request comprising a user identity, a user transaction, and a user transaction parameter. Selecting the time-bound constraint record corresponding to the user identity provided in the request. Determining whether the user transaction and the user transaction parameter in the request correspond with the transaction and the transaction parameter in the time-bound constraint record. Determining whether the time the request is received is within the time period in the time-bound constraint record. Evaluating the rule in the time-bound constraint record. Permitting or denying the request depending upon evaluation of the rule, and updating an audit log depending upon the evaluation of the rule.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### BACKGROUND

1. Field of the Invention

The present invention is related to the field of on-line services. In particular, the present invention is related to a method and apparatus to create and execute time-bound constraints.

2. Description of the Related Art

A time-bound constraint may be defined as a rule or a set of rules that allow a certain process to occur or not occur based upon aspects (parameters) of the process that have been gathered over a period of time. A rule may comprise one or more statements that operate on data and evaluates to a particular outcome e.g., true or false, yes or no etc. A rule may also contain within it another rule i.e., a nested rule. The pseudo code below is an example of a time-bound constraint.

1: Indicator ‘TOTALWITHDRAWAMOUNT’ (Amount withdrawn during withdraw period)<$500

2: And Indicator ‘WITHDRAWPERIOD’ (Period in which amount is withdrawn)=Current day.

In the time-bound constraint example above, a determination is made whether a user has withdrawn $500 from the user's account during the programmed current day period. If the user has already withdrawn the stated amount during the stated period, then the user may be denied the ability to withdraw any more funds from the account until the stipulated current time period (current day) has ended. Thus, a time-bound constraint may be used to determine whether a user is granted or denied permission to perform a requested operation at a particular time.

In an environment wherein there is a high transaction rate, e.g., in a financial institution, a substantial number of users may access their accounts online via a web-browser. In such an environment, there is a tension between the need to insert records in an audit log (i.e., a log that keeps a sequential record of each user interaction with the financial institution) and the need to query the audit log quickly to evaluate a time-bound constraint. For the example in the pseudo code above, the audit log would have to be searched for all transactions for the user during the stated time period. Optimizing the audit log for searching (e.g., adding table indexes) has the side effect of slowing down audit log inserts. Thus, the conventional method of accessing an audit log to evaluate a time-bound constraint is inefficient.

### BRIEF SUMMARY OF THE DRAWINGS

Examples of the present invention are illustrated in the accompanying drawings. The accompanying drawings, however, do not limit the scope of the present invention. Similar references in the drawings indicate similar elements.

FIG. 1 illustrates a time-bound constraint record according to one embodiment of the invention.

FIG. 2 illustrates a flow diagram to execute a time-bound constraint according to one embodiment of the invention.

FIG. 3 illustrates a software engine to implement a time-bound constraint according to one embodiment of the invention.

FIG. 4 illustrates an apparatus for setting up and executing a time-bound constraint according to one embodiment of the invention.

### DETAILED DESCRIPTION

Described is a method and apparatus to execute a time-bound constraint (TBC) comprising, generating a TBC record comprising a user identity, a transaction, a transaction parameter, a time period, an update time, a rule and an accumulator. Receiving a request said request comprising a user id, a user transaction and a user transaction parameter. Selecting the TBC record corresponding to the user identity provided in the request. Determining whether the user transaction and the user transaction parameter in the request correspond with the transaction and the transaction parameter in the TBC record. Determining whether the time the request is received is within the time period in the time period field of the TBC record. Evaluating the rule stored in the TBC record. Permitting or denying the request depending upon evaluation of the rule, and updating an audit log depending upon the evaluation of the rule.

In the following description numerous specific details are set forth in order to provide a thorough understanding of the present invention. It will be apparent, however, to one of ordinary skill in the art that the present invention may be practiced without these specific details. In other instances, well-known architectures, steps, and techniques have not been shown to avoid obscuring the present invention.

The invention may utilize a distributed computing environment. In a distributed computing environment, program modules may be physically located in different local and remote memory storage devices. Execution of the program modules may occur locally in a stand-alone manner or remotely in a client/server manner. Examples of such distributed computing environments include local area networks, enterprise-wide computer networks, and the global Internet. Lastly, repeated usage of the phrase “in one embodiment” does not necessarily refer to the same embodiment, although it may.

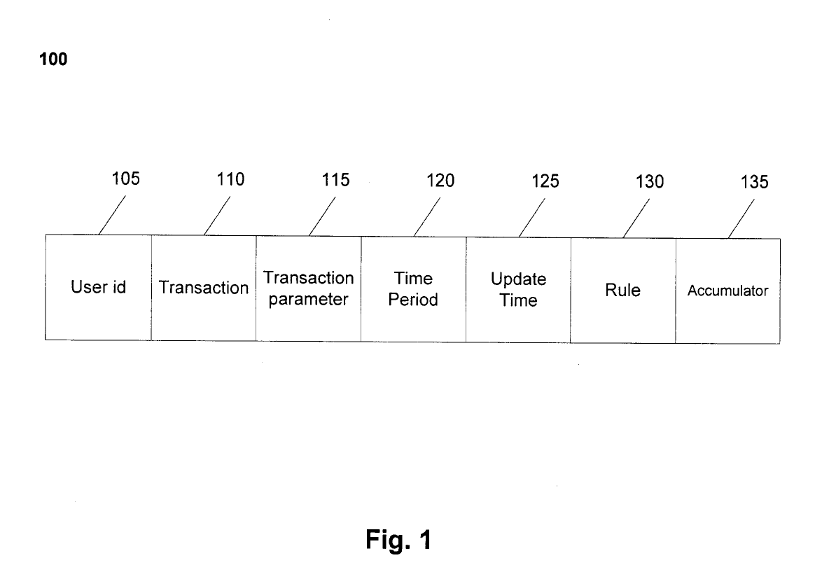

FIG. 1 illustrates a TBC record according to one embodiment of the invention. As illustrated in FIG. 1, the TBC record 100 comprises one or more fields corresponding to a particular user. In one embodiment of the invention, each TBC record may comprise e.g., a record stored as a row in a table in a database. In one embodiment of the invention, the TBC record is created when a user signs up for a service e.g., when the user opens an account at a financial institution, opens an account at a brokerage house etc. In one embodiment of the invention, the TBC record comprises a user id 105, e.g., a user name, provided by the user when the user signs up for service.

The TBC record also comprises a transaction 110 that determines the type of transaction the user may request in the future as part of the service e.g., a request to withdraw funds from the user's account. In this case, the transaction field 110 may have a ‘WITHDRAWAL’ keyword written in the transaction field 110. To deposit funds to the user's account, the transaction field 110 may have a ‘DEPOSIT’ keyword written in the transaction field of TBC record 110. To sell a particular stock from a user's equity portfolio the transaction field 110 may have a ‘SELL’ keyword written in the transaction 110, etc. Therefore, depending on the type of service the user signs up for, the keyword in the transaction field 110 determines the transaction parameters written in transaction parameter field 115.

The transaction parameter field 115 in the TBC record 100 may comprise one or more transaction parameters that defines the transaction, e.g., if the transaction field 110 has a ‘WITHDRAW’ keyword, then the transaction parameter 110 field may contain the account number from which the user's funds are withdrawn. Similarly, if the transaction field 110 has a ‘SELL’ keyword then the transaction parameter field may contain the name of the equity and/or the quantity of the equity possessed by the user. Thus, a transaction parameter field 115 contains the object upon which the transaction 110 operates.

The time period field 120 of the TBC record 100 determines the time period during which a rule stored in the rule field 130 is applicable. For example, if the parameter stored in the time period field 120 is ‘current day’, and the parameter stored in transaction field 110 is ‘WITHDRAW’. Then, the rule stored in rule field 130 e.g., WITHDRAW<$500 is applicable for the current day. This means that the rule will return a ‘True’ outcome if the amount withdrawn during the period of the current day is less than $500. Although, the example above illustrates a rule for withdrawing funds, one having ordinary skill in the art will appreciate that any rule may be stored in rule field 130, with corresponding fields for evaluating the rule stored at least in transaction field 110 and transaction parameter field 115.

In one embodiment if the invention, update time field 125 in a TBC record 100 stores the date and/or time when rule 130 executes and the accumulator 135 is updated. In one embodiment of the invention, the accumulator 135 contains a running total of one or more parameters required by the rule 130. For the example above, the first time that a user withdraws funds from the user's account, the amount withdrawn is stored in the accumulator 115. The next time the user withdraws funds from the account, the amount requested to be withdrawn by the user is added to the funds previously withdrawn (stored in accumulator 135) to determine if the rule 130 is violated.

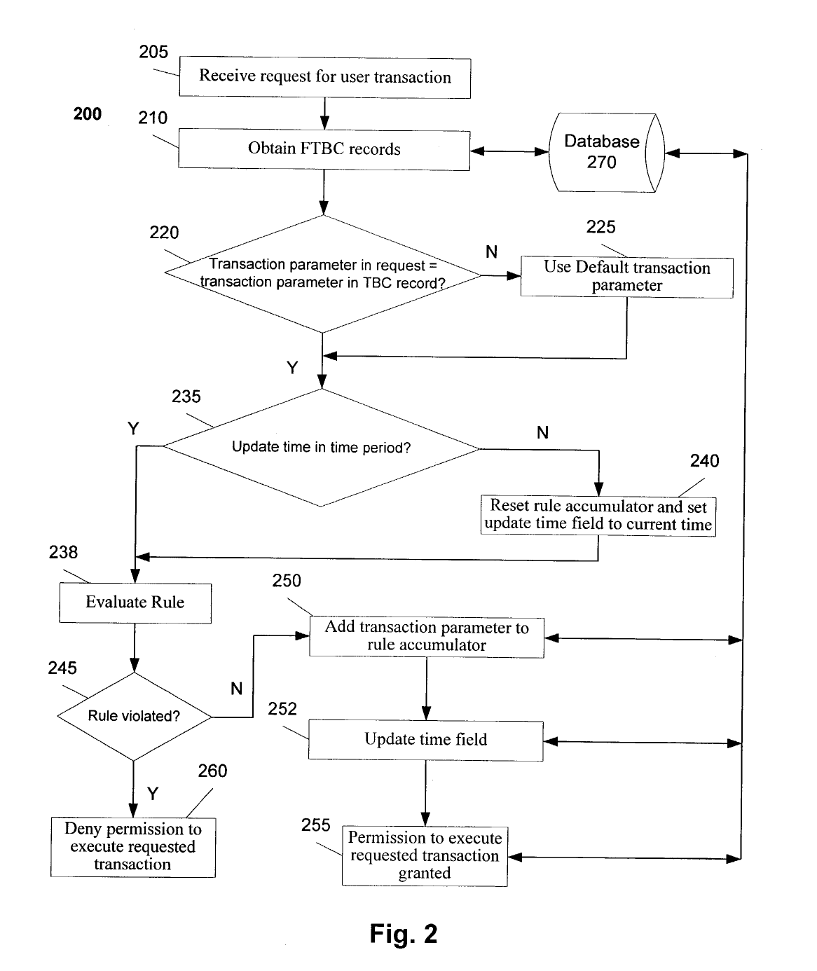

FIG. 2 illustrates a flow diagram to execute a TBC according to one embodiment of the invention. The flow diagram illustrated in FIG. 2 will be explained with the assumption that a user opens a checking account (having account number xyz) at a financial institution. The limit set on the account is to not permit withdrawals of more than $500 during any given day. During the initial setting up of the checking account the user provides the financial institution with authentication information e.g., a user id and a password in order to effect transactions on-line with the user's account at the financial institution. In one embodiment of the invention, the information received from the user during initial set-up of the user account is written to a TBC record corresponding to the user id provided by the user. Thus, for the example above, the user id provided is written to user id field 105 of the TBC record. Keyword ‘WITHDRAW’ may be written to the transaction field 110 of the TBC record to indicate that the rule that is associated with the withdrawal of funds is to be followed. The user account number ‘xyz’ may be written to transaction parameter field 115, keyword ‘current day’ may be written to time period field 120, and ‘Not more than $500’ may be written to rule field 130 of the TBC record. In addition, update time field 125 may be initialized to the current time and accumulator field 135 may be initialized to 0. In one embodiment of the invention, more than one TBC record may be created for a particular user id 105, thus e.g., there may be another TBC record created having the same user id for depositing funds at the financial institution. Alternate embodiments of the invention may include additional fields within the same TBC record to permit the operation of one or more other transactions thereby eliminating the need to create additional records associated with the same user id.

Although the example illustrated above is for withdrawing funds from an account at a financial institution, one having ordinary skill in the art will appreciate that the method illustrated may be used to obtain any information previously obtained by querying audit logs.

As illustrated in FIG. 2, at 205 a request is received by either the financial institution or by an application service provider (ASP) that provides services to the financial institution. In one embodiment of the invention, the request comprises a user id, a transaction, a transaction parameter, and a transaction amount. At 210, using the user id in the request, the TBC records corresponding to the user id 105 are selected e.g., from database 270. From the selected records corresponding to the particular user id the TBC record corresponding to the transaction in the request is selected. In one embodiment of the invention, the request may contain the transaction and the transaction parameter, and the user id may be obtained when the user authenticates at the financial institution prior to requesting a transaction.

Thus, for example, if the request contains a ‘WITHDRAW’ transaction to withdraw a transaction amount of $300 from transaction parameter ‘xyz’ account, the records corresponding to the user id provided in the request are selected in database 270. The selected records are searched for keyword ‘WITHDRAW’ in transaction field 110. In one embodiment of the invention, the transaction amount may be an amount that further defines the transaction e.g., x dollars, y shares of an equity etc.

At 220, a determination is made whether the user transaction parameter of the request matches the transaction parameter 115 of the TBC record. Thus, at 220, for the example above, a determination is made whether the user transaction parameter (i.e., the user account number) ‘xyz’ contained in the request, matches the transaction parameter 115 (the account number) stored in the TBC record 100.

If at 220, the user transaction parameter does not match the transaction parameter 115, then at 225, a default transaction parameter may be used. For example, if a user has multiple accounts at a financial institution, and designates a particular account (i.e., a default account) for day-to-day transactions, then when a request is received and the request does not contain a transaction parameter, the default account may be used for the transaction. Thereafter, the process goes to 235 wherein a determination is made whether the time the request is received is within the time period 120 that is stored in the TBC record 100.

So also, if at 220 the user transaction parameter in the request matches the transaction parameter 115 of the TBC record, at 235, a determination is made whether the time the request is received is within the time period 120 stored in the TBC record 100.

However, if at 235 the time the request is received is not within the time period 120 stored in the TBC record, at 240, the accumulator 135 is reset with a default value e.g., 0. Thereafter, the update time 125 is reset to the time the request is received. The process then flows to 238 wherein the rule 130 is evaluated.

In one embodiment of the invention, rule 130 is evaluated for fixed time-bound constraints, in other embodiments of the invention rule 130 is evaluated for variable-time bound constraints. A fixed time-bound constraint comprises a rule wherein the accumulator 135 is reset at fixed time intervals. For example, a fixed time-bound constraint having a time period 120 of a “current day” may have the update time 125 and the accumulator 135 reset each night at 12:00 am.

A rolling time-bound constraint comprises a rule that tracks information within a sliding window. For example, “the previous 24 hours”. For a rolling time-bound constraint the accumulator 135 is not reset at a particular time as in the case of a fixed time-bound constraint. Instead, transactions that are outside the sliding window are deleted from the accumulator 135. In one embodiment of the invention, to implement rolling time-bound constraints the accumulator may be divided into “bins”. As each bin falls outside the sliding window, the information stored in the bin is reset e.g., to 0. Thus for example, for a rolling time-bound constraint having a time period of “the previous 24 hours”, a bin size of one hour might be used to implement the rolling time-bound constraint.

At 235, if the time the request is received is within the time period 120, at 238, the rule 130 in the TBC record 100 is evaluated. For the example above, if a previous withdrawal of $250 occurred within the current time period (i.e., within the current day) at 245, rule 130 is evaluated at 238. In one embodiment of the invention, evaluating the rule 130 comprises determining whether the outcome of the rule is ‘True’ or ‘False’. At 245, a decision is made whether the rule 130 is violated. For the example above, the rule 130 is violated (i.e., the outcome of the rule is ‘True’) since the sum of the previous withdrawal $250 and the current requested withdrawal $300 exceeds the maximum permitted withdrawal amount i.e., $500 during the current day period. If the rule is violated, then at 260 permission to execute the transaction in the request is denied. Thus, for the example above, the user will not be able to withdraw the requested amount. In one embodiment of the invention, the user may be sent a message to inform the user that the maximum withdrawal limit set has been exceeded and therefore the request is denied. In one embodiment of the invention, the user may be sent a message informing the user of the permissible amount the user can withdraw during the current time period.

However, if at 245 the rule 130 is not violated at 250 the accumulator 135 is updated. In one embodiment of the invention, the accumulator 135 is updated by adding the existing value of the accumulator to the amount requested by the user. Thus, for the example above, if the user has within the time period 120 previously withdrawn $100 (instead of the previously stated $250), the rule is not violated, and the accumulator 135 which has $100 stored therein, is updated to $300+$100=$400. Thereafter, in one embodiment of the invention, at 252 the update time field 125 is updated with the time the request is received. After updating the update time field 125, permission is granted at 255 to execute the user transaction. Thus, for the example above, permission is granted to withdraw the requested funds from the user account since the accumulator 135 has $400 stored therein and the maximum of $500 is not exceeded during the time period 120. Thereafter, the audit log is updated by e.g., an entry to reflect the withdrawal of funds from the user's account. Alternatively, the audit log entry may be updated after the funds are successfully withdrawn from the user's account. Thus, if the withdrawal of funds fails, e.g., due to insufficient funds in the user's account, the amount added to the rule accumulator at 250 may be subtracted back out, since the amount was not actually withdrawn from the user's account.

Thus, by checking a TBC record instead of querying the audit log for transactions, the writing of transactions to the audit log is not delayed by the necessity to optimize for queries and therefore, time bound constraints are efficiently evaluated.

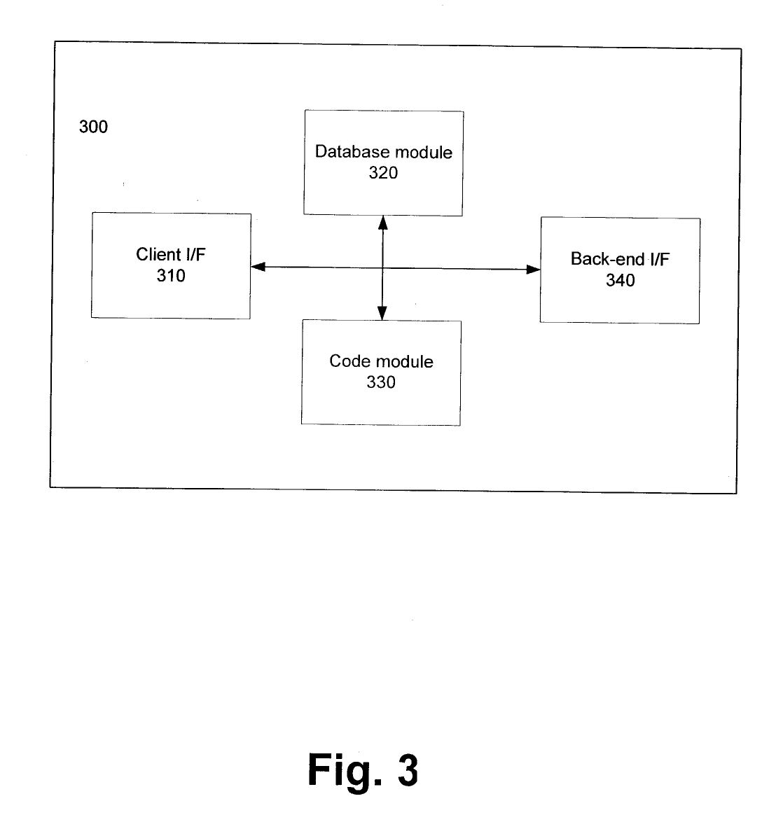

FIG. 3 illustrates a software engine to implement a time bound constraint according to one embodiment of the invention. As Illustrated in FIG. 3, the time bound constraints module 300 comprises a client interface 310, a Database module 320, a code module 330, and a back-end interface 340 coupled to each other as shown. The client interface 310 interfaces with a client e.g., a customer of a financial institution. In particular, client interface 310 may interface with a customer's computer, PDA, wireless device, etc. via a network e.g., the Internet. Client interface 310 may thus receive authenticating information for a customer e.g., a user id and password, a user transaction, a user transaction parameter, etc.

Database module 320 coupled to code module 330, client interface 310 and to back-end interface 340 comprises one or more databases e.g., relational databases to store TBC records, authentication information, etc.

Code module 330 comprises the program code to execute a TBC according to the method illustrated with respect to FIGS. 1 and 2. For example, code module 330 may analyze the request received from a client via client interface 310 and write the information to the fields of a TBC record 100 during initial setup, and during execution of rule 130 as illustrated with respect to FIGS. 1 and 2. Back-end interface 340 coupled to database module 320, code module 330, and client interface 310 may send and/or receive authentication and TBC information from a financial institutions remote server. In one embodiment of the invention, back-end interface 340 may receive marketing information tailored to the particular user and send the information to client interface 310 for displaying on the user's screen. The marketing information may be displayed e.g., when the user logs on to the financial institution's web site to provide the user's authentication information and/or to effect transactions. In one embodiment of the invention marketing information may include e.g., products and services offered by the financial institution.

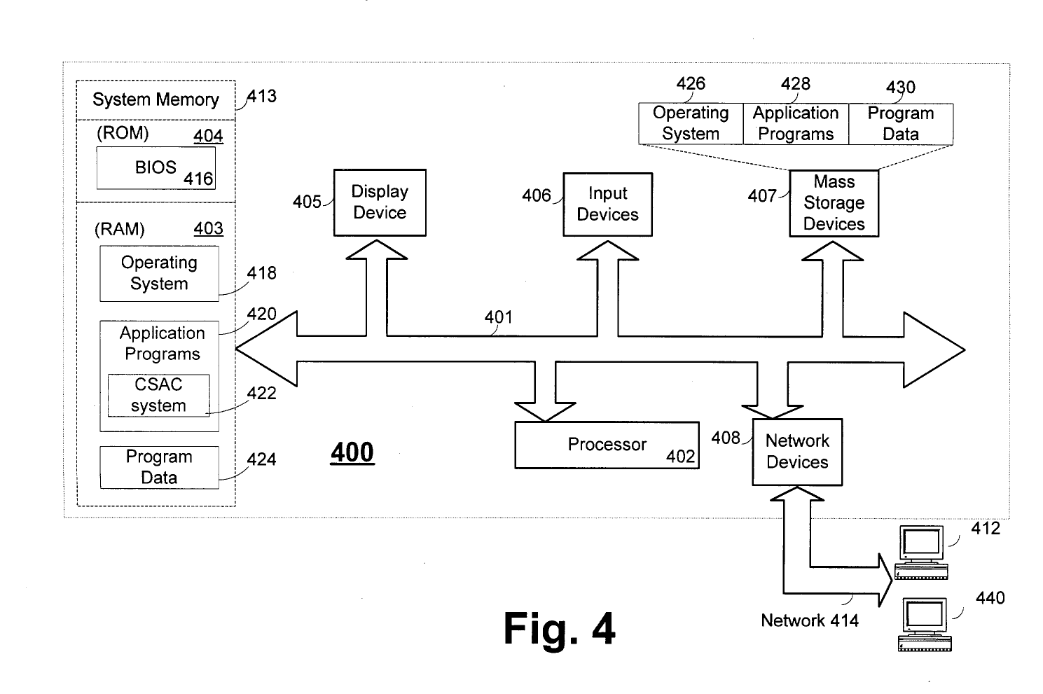

FIG. 4 illustrates an apparatus for setting up and executing a time bound constraint according to one embodiment of the invention. In general, such computer systems as illustrated by FIG. 4 include a processor 402 coupled through a bus 401 to system memory 413 and a mass storage device 407.

System memory 413 comprises a read only memory (ROM) 404 and random access memory (RAM) 403. ROM 404 comprises basic input output system (BIOS) 416. RAM 403 comprises operating system 418, application programs 420, and program data 424. Application programs 420 include the program code for setting up and executing TBCs as illustrated with respect to FIGS. 1 and 2. Program data 424 may include the authentication data, TBC setup information, and user requests. Mass storage device 407 represents a persistent data storage device, such as a floppy disk drive, fixed disk drive (e.g., magnetic, optical, magneto-optical, or the like), or streaming tape drive. Mass storage device 407 may store application programs 428 including the program code for setting up and executing a TBC. Mass storage device 407 may also store the operating system 426 for computer system 400, and program data 430. The program data may include, e.g., the results obtained from execution of rule 130, and update information for update time field 125, and accumulator 135. Processor 402 may be any of a wide variety of general purpose processors or microprocessors (such as the Pentium® processor family manufactured by Intel® Corporation), a special purpose processor, or a specifically programmed logic device.

Processor 402 is operable to receive instructions which, when executed by the processor cause the processor to execute instructions to implement the method described with respect to FIGS. 1 and 2.

Display device 405 is coupled to processor 402 through bus 401 and provides graphical output for computer system 400. Input devices 406 such as a keyboard or mouse are coupled to bus 401 for communicating information and command selections to processor 402. Also coupled to processor 402 through bus 401 is an input/output interface (not shown) which can be used to control and transfer data to electronic devices (printers, other computers, etc.) connected to computer system 400. Computer system 400 includes network devices 408 for connecting computer system 400 to one or more networks 414. Network 414 may be communicatively coupled to one or more remote users 412 and 440. Network devices 408, may include Ethernet devices including network adapters, phone jacks and satellite links. It will be apparent to one of ordinary skill in the art that other network devices may also be utilized.

One embodiment of the invention may be stored entirely as a software product on mass storage 407. Another embodiment of the invention may be embedded in a hardware product, for example, in a printed circuit board, in a special purpose processor, or in a specifically programmed logic device communicatively coupled to bus 401. Still other embodiments of the invention may be implemented partially as a software product and partially as a hardware product.

Embodiments of the invention may be represented as a software product stored on a machine-accessible medium (also referred to as a computer-accessible medium or a processor-accessible medium). The machine-accessible medium may be any type of magnetic, optical, or electrical storage medium including a diskette, CD-ROM, memory device (volatile or non-volatile), or similar storage mechanism. The machine-accessible medium may contain various sets of instructions, code sequences, configuration information, or other data. Those of ordinary skill in the art will appreciate that other instructions and operations necessary to implement the described invention may also be stored on the machine-accessible medium.

Thus, a method and apparatus have been disclosed to create and execute time-bound constraints. While there has been illustrated and described what are presently considered to be example embodiments of the present invention, it will be understood by those skilled in the art that various other modifications may be made, and equivalents may be substituted, without departing from the true scope of the invention. Additionally, many modifications may be made to adapt a particular situation to the teachings of the present invention without departing from the central inventive concept described herein. Therefore, it is intended that the present invention not be limited to the particular embodiments disclosed, but that the invention include all embodiments falling within the scope of the appended claims.

What is claimed is:

1. A method to execute a time-bound constraint comprising:
generating a time-bound constraint record comprising a user id, a transaction, a transaction parameter, a time period, an update time, a rule and a rule accumulator;
receiving a request said request comprising a user identity, a user transaction, and a user transaction parameter;
selecting the time-bound constraint record corresponding to the user identity provided in the request;
determining whether the user transaction and the user transaction parameter in the request correspond with the transaction and the transaction parameter in the time-bound constraint record;
determining whether the time the request is received is within the time period in the time-bound constraint record;
evaluating the rule in the time-bound constraint record;
permitting or denying the request depending upon evaluation of the rule; and
updating an audit log depending upon the evaluation of the rule.

2. The method of claim 1 wherein generating a time-bound constraint record comprising a user id, a transaction, a transaction parameter, a time period, an update time, a rule and a rule accumulator comprises generating a time-bound constraint record during set-up of a user account.

3. The method of claim 1 wherein receiving a request said request comprising a user identity, a user transaction, and a user transaction parameter comprises a user logging into a web-site of at least one of a financial institution and an application service provider and providing the at least one of the financial institution and the application service provider the user identity, the user transaction, and the user transaction parameter.

4. The method of claim 1, wherein selecting the time-bound constraint record corresponding to the user identity provided in the request comprises searching a database for a time-bound constraint record corresponding to the user identity.

5. The method of claim 1, wherein determining whether the time the request is received is within the time period in the time-bound constraint record comprises, determining whether the time the request is received is within any one of a time period of a fixed time-bound constraint record and a time period of a rolling time-bound constraint record.

6. The method of claim 1, wherein evaluating the rule in the time-bound constraint record comprises determining whether the rule stored in the time-bound constraint record evaluates to any one of a ‘True’ and a ‘False’.

7. The method of claim 6 wherein updating an audit log depending upon the evaluation of the rule comprises any one of writing to the audit log if the rule evaluates to ‘True’ and writing to the audit log if the rule evaluates to ‘False’.

8. An article of manufacture comprising:
a machine-accessible medium including instructions that, when executed by a machine, causes the machine to perform operations comprising:
generating a time-bound constraint record comprising a user id, a transaction, a transaction parameter, a time period, an update time, a rule and a rule accumulator;
receiving a request said request comprising a user identity, a user transaction, and a user transaction parameter;
selecting the time-bound constraint record corresponding to the user identity provided in the request;
determining whether the user transaction and the user transaction parameter in the request correspond with the transaction and the transaction parameter in the time-bound constraint record;
determining whether the time the request is received is within the time period in the time-bound constraint record;
evaluating the rule in the time-bound constraint record;
permitting or denying the request depending upon evaluation of the rule; and updating an audit log depending upon the evaluation of the rule.

9. The article of manufacture of claim 8, wherein said instructions for generating a time-bound constraint record comprising a user id, a transaction, a transaction parameter, a time period, an update time, a rule and a rule accumulator comprises further instructions for generating a time-bound constraint record during set-up of a user account.

10. The article of manufacture of claim 8, wherein said instructions for receiving a request said request comprising a user identity, a user transaction, and a user transaction parameter comprises further instructions for a user logging into a web-site of at least one of a financial institution and an application service provider and providing the at least one of a financial institution and the application service provider the user identity, the user transaction, and the user transaction parameter.

11. The article of manufacture of claim 8, wherein said instructions selecting the time-bound constraint record corresponding to the user identity provided in the request comprises further instructions for searching a database for a time-bound constraint record corresponding to the user identity.

12. The article of manufacture of claim 8, wherein said instructions for determining whether the time the request is received is within the time period in the time-bound constraint record comprises further instructions for, determining whether the time the request is received is within any one of a time period of a fixed time-bound constraint record and a time period of a rolling time-bound constraint record.

13. The article of manufacture of claim 8, wherein said instructions for evaluating the rule in the time-bound constraint record comprises further instructions for determining whether the rule stored in the time-bound constraint record evaluates to any one of a ‘True’ and a ‘False’.

14. The article of manufacture of claim 13, wherein said instructions for updating an audit log depending upon the evaluation of the rule comprises further instructions for any one of writing to the audit log if the rule evaluates to ‘True’ and writing to the audit log if the rule evaluates to ‘False’.

15. An apparatus comprising:
a bus;
a data storage device coupled to said bus; and
a processor coupled to said data storage device, said processor operable to receive instructions which, when executed by the processor, causes the processor to
generate a time-bound constraint record comprising a user id, a transaction, a transaction parameter, a time period, an update time, a rule and a rule accumulator;
receive a request said request comprising a user identity, a user transaction, and a user transaction parameter;
select the time-bound constraint record corresponding to the user identity provided in the request;
determine whether the user transaction and the user transaction parameter in the request correspond with the transaction and the transaction parameter in the time-bound constraint record;
determine whether the time the request is received is within the time period in the time-bound constraint record;
evaluate the rule in the time-bound constraint record;
permit or deny the request depending upon evaluation of the rule; and update an audit log depending upon the evaluation of the rule.

16. The apparatus of claim 15, wherein the processor to generate a time-bound constraint record comprising a user id, a transaction, a transaction parameter, a time period, an update time, a rule and a rule accumulator comprises the processor to generate a time-bound constraint record during set-up of a user account.

17. The apparatus of claim 15, wherein the processor to receive a request said request comprising a user identity, a user transaction, and a user transaction parameter comprises a user logging into a web-site of at least one of a financial institution and an application service provider and providing the processor at least one of the financial institution and the application service provider the user identity, the user transaction, and the user transaction parameter.

18. The apparatus of claim 15, wherein the processor to select the time-bound constraint record corresponding to the user identity provided in the request comprises the processor to search a database for a time-bound constraint record corresponding to the user identity.

19. The apparatus of claim 15 wherein the processor to determine whether the time the request is received is within the time period in the time-bound constraint record comprises the processor to determine whether the time the request is received is within any one of a time period of a fixed time-bound constraint record and a time period of a rolling time-bound constraint record.

20. The apparatus of claim 15 wherein the processor to evaluate the rule in the time-bound constraint record comprises the processor to determine whether the rule stored in the time-bound constraint record evaluates to any one of a ‘True’ and a ° False.

21. The apparatus of claim 15 wherein the processor to update an audit log depending upon the evaluation of the rule comprises the processor to any one of write to the audit log if the rule evaluates to ‘True’ and writing to the audit log if the rule evaluates to ‘False’.
